(19) United States
(12) Patent Application Publication
(10) Pub. No.: US 2003/0051944 A1
(43) Pub. Date: Mar. 20, 2003

(54) Descent control device

(76) Inventor: Richard D. Shea, Dallas, TX (US)

Correspondence Address: STEPTOE & JOHNSON PLLC, Sixth Floor, Bank One Center, P.O. Box 2190, Clarksburg, WV, 26302-2190, US

(21) Appl. No.: 10/245,542

(22) Filed: Sep. 16, 2002

Related U.S. Application Data
(60) Provisional application No. 60/322,376, filed on Sep. 14, 2001.

(51) Int. Cl. A62B 35/00

(52) U.S. Cl. 182/193; 182/5

(57) ABSTRACT

A descent control device for use with a rope for controlling a user's rate of descent down the rope. The device has a frame with a grip, three openings and an internal cavity connecting the openings, wherein two openings form a channel extending along a generally horizontal axis. The grip extends away from the frame along a generally vertical axis. A handle is rotatably mounted to the frame within the internal cavity and extends away from the frame in a direction generally parallel to the grip. One end of the handle is preferably Y-shaped and forms an upper boundary to the channel such that the end of the handle is adapted for modifying the width of the channel upon rotation of the handle. A cover is pivotally mounted to the frame for maintaining the rope in the channel.

### CROSS-REFERENCE TO RELATED APPLICATIONS This application claims the benefit of U.S. Application No. 60/322,376, filed Sep. 14, 2001.

### BACKGROUND OF THE INVENTION

1. Field of Invention

This invention relates to descent control devices, and more specifically, to a break-fall safety device adapted to be operated with a single hand in which a user controls his/her descent while eliminating the possibility of an uncontrolled free-fall.

2. Related Art

Descent control devices of various types are well known and are often utilized as fire escape devices, as rappel devices for search and rescue teams, and as evacuation devices for leaving hovering aircraft such as helicopters. Numerous problems have been associated with these conventional descent devices. First, they may be highly complex and difficult to set tip in an emergency situation. Second, their complex nature may make them unusable without special training. Third, many of the devices are not sufficiently small and portable to be completely desirable as fire escape devices. Fourth, the majority of the devices require both hands of the user to operate.

In the art of descent control devices, a primary consideration is safety. Preferred devices are those which are specifically designed to minimize jamming-up during operation, so that the person descending does not become stuck in mid-air part way through the descent, and so that the rate of descent can be easily controlled under almost every condition.

With safety and emergency equipment, factors such as cost., portability, and size can become very important. If the equipment is too expensive, it will not typically be purchased, since consumers will often consider the probability of needing the equipment as being not worth the expense. Thus, when the emergency happens to them, they will have no proper equipment. If the device is not sufficiently portable, it cannot be rapidly moved to the location of use when needed. If the device is not suitably small, it might not be stored near those locations where it is most likely to be needed. It is readily seen that the more these features can be desirably improved, the better will be the descent control device.

Additionally, safety and emergency equipment should be relatively easy to use. During emergencies, the operator's attention is often divided between numerous concerns and rapid action is essential. Thus, the easier the equipment is to use, the higher the probability will be that it can serve its purpose. Additionally, the use of safety and emergency equipment is often only infrequently and insufficiently practiced. Therefore, the easier the equipment is to use, the more likely it will be that the user will remember its method of operation between uses. Further, it is best if one of ordinary intelligence can simply look at the equipment and figure out how to use it, having only seen the equipment in use once before or having never seen the equipment in use but rather only having had its use explained. Therefore, in this art, the more simple the device is or appears, the more desirable it may be as a descent control device.

Rogelja discloses a descender in U.S. Pat. No. 5,597,052, and repeated in international patent application having publication no. WO 01/43830, having only a single braking surface but two separate means for braking that requires a user to operate the descender with two hands. That is, the descender exerts pressure on a rope traversed through the descender at only one location—one point of compression on the rope. As shown in FIG. 2, a rope traverses a path through a handle 17(around two sheaves), across a baseplate 11, and around and through a lever 23. Both the handle 17 and the lever 23 are pivotally connected to the baseplate 11 such that a user's harness connected (via connection means 26) at the end of the baseplate 11 is parallel to the handle 17 and lever 23. In operation, a user passes the rope through the descender as shown in FIG. 2. There are two separate ways in which the user may control his/her descent down the rope. First, the user may engage the handle 17 by pressing it toward the baseplate 11. This action causes the second sheave 15 to compress the rope against the braking surface 24, thereby slowing and/or stopping the user's descent. Second, the user may move the tail of the rope away from the baseplate 11, in direction F on FIG. 3, which in turn moves the distal end of the lever 23 away from the baseplate 11, causing the braking surface 24 to rotate toward the second sheave 15, thereby compressing the rope. Regardless of which of these means the user engages, the rope is compressed (and hence braked) at only one location—the point of the rope between the second sheave 15 and the braking surface 24. Also, the user must use two hands to operate this descender: one hand to hold and operate the handle 17, and one hand to hold the tail of the rope after the lever 23. Lastly, the user is connected to the descender at a point on a distal end of the baseplate 11 (see FIG. 1) such that the weight of the user is positioned at a distal end of the baseplate 11. This design results in the user being positioned in the same plane as the vertical axis of the descender and parallel to the path of the rope through the descender.

U.S. Pat. No. 6,155,384 to Paglioli discloses a break-fall device used to prevent an unintentional free-fall. This device does not provide any means by which a user may control his/her rate of descent. It is merely an add-on type of accessory such that a user must employ conventional techniques and equipment for repelling. The device has only a single braking surface point wherein the rope is compressed between cam 2 and counter-cam 8. In addition, as with conventional devices, in normal operation a user's connection means is along a vertical axis of the device, thereby being parallel to the path of the rope through the device (see FIG. 6).

U.S. Pat. No. 6,029,777 is another descender by Rogelja wherein the descender can be used in two different modes: controlling the rate of descent (wherein an adjustable stop means compresses the rope to control the speed of the rope through the device) and as a belaying device (wherein the rope runs freely through the device). A user connects to this descender in such a manner that the connection and the weight of the user is positioned at a distal end of the baseplate and parallel to the path of the rope through the descender. This descender is complex in that it has many moving parts and cannot be easily installed and operated by a novice user—especially in an emergency situation. Also, the device must be pre-set to operate in a desired mode (controlled descent v. belaying), such that an inexperienced user of this device many not be able to pre-set and use the device in a hurry (as required in an emergency situation). Lastly, the descender is not designed to be used by a single hand of the user due to the lever design and the need to pre-set the operational mode of the device.

U.S. Pat. No. 5,954,153, also to Rogelja, discloses an earlier version of his later descender disclosed in the '052 patent described above. This descender does not have the lever 23 of the '052 patent. Also, there is only one braking surface for compressing a rope which is the space between the second sheave 15 and the braking surface of the stop member 18. Lastly, the user is connected at a distal end of the baseplate 11, resulting in the user's weight being positioned at a location on the baseplate 11 that is parallel to the handle 17, to the vertical axis of the descender, and to the path of the rope through the descender.

U.S. Pat. No. 5,850,893 to Hede, et al., discloses a self-locking descender having a lever 22 which, upon rotation, compresses a rope at a single point of braking between a boss 34 and a braking surface 28 of a stud 14. As with the other such devices, a user is connected to this device at a hole 38 at the distal end of the flange 12 that is parallel to the lever 22, to the vertical axis of the descender, and to the path of the rope through the descender.

U.S. Pat. No. 5,577,576 to Petzl, et al., discloses a self-locking descender. This descender only has a single point of braking wherein the rope is compressed between the braking surface 28 and cam 17. As with the other such devices, a user is connected to this device at a hole 38 at the distal end of the flange 14 that is parallel to the handle 24, to the vertical axis of the descender, and to the path of the rope through the descender.

U.S. Pat. No. 5,360,083 to Hede discloses a disengageable descender that stops a user's descent upon the activation of a tension force on the rope and upon the incorrect winding of the rope through the device. In this device a user is connected to the device at a hole 46 located on the distal end of a flange 14. Therefore, the user, and his/her weight distribution, is in a line parallel to the handle 24, to the vertical axis of the descender, and to the path of the rope through the descender. The user must move the handle 24 down and away (in direction F2) from the device in order to descend. This device also has a single of point of braking by compressing the rope between the braking surface 28 of the pad 26 and the cam 17 of the pulley 16.

In addition, to the above patented devices, Tactical & Rescue Gear offers for sale a descender called The Master Series Descenders for which it advertises “patent pending.” The disadvantages with this device are that it is a heavy and cumbersome device, that there is still only a single point of braking along the rope, and that the user's connection means to the device is at a point on the distal end of the device. Therefore, the user's weight is positioned along the vertical axis of the device and is parallel to the path of the rope through the device. In operation, when descending rapidly, the heat build up from the resulting friction is very great, thereby causing the device to heat up. Because the hand braking lever is parallel to and adjacent to the rope in the device, the handle becomes too hot to hold. To descend a long distance, a user must wear heavy gloves or take multiple breaks along the descent to allow the heat build-up to dissipate.

Therefore, there is a need for a light-weight, and easy to use descender that can be quickly and easily used by an inexperienced person. There is a need for such a descender to stop the descent of a person if the person becomes incapacitated or panics during the descent. There is a further need for the descender to not heat up and become usuable by the user during use. There is still a further need for a descender in which the braking mechanism is not parallel to the path of the rope through the device, while employing multiple points of braking, or compression of the rope, along the path of the rope through the device.

### SUMMARY OF THE INVENTION

The present invention solves the problems encountered with other descent control devices by providing a mechanically simple, compact, and easy to use descender for use when rappelling down a rope. The descent control device has a frame with a grip, three openings and an internal cavity connecting the openings, wherein two openings form a channel extending along a generally horizontal axis. The grip extends away from the frame along a generally vertical axis. A handle is rotatably mounted to the frame within the internal cavity and extends away from the frame in a direction generally parallel to the grip. One end of the handle is located within the internal cavity of the frame and is preferably Y-shaped. This end of the handle forms an upper boundary to the channel such that the end of the handle is adapted for modifying the width of the channel at two separate locations upon rotation of the handle. A cover is pivotally mounted to the frame for maintaining the rope in the channel.

An aspect of the invention is a descender for controlling rate of descent down a rope, including a frame having a channel for receiving a segment of rope, a tension control device for opening or constricting the channel of the frame, thereby regulating passage of the rope through the frame, and a cover for securing the rope in the cavity. The cover is rotatably connected to the frame by a pin passing through the cover, the tension control device, and the frame.

A feature of the invention is that it allows for one-hand rappelling. This is particularly an advantage in police and military applications where the user may be required to use his or second hand and arm to fire a weapon.

Another feature of the invention is that a user connects to the device in a line perpendicular to the path of the rope through the device thereby enabling the weight of the user to activate the braking system.

Another feature of the invention is to provide multiple points of compression along the length of the rope through the device.

Another feature of the invention is a rotating cover to facilitate threading a segment of rope through the descender.

Another feature of the invention is a simple means for attaching the descender to a user.

An advantage of the invention is that, unlike prior descenders, it is compact and light-weight enough for a user to easily manipulate the handle with one hand.

Another advantage of the invention is that it makes rappelling safer and easier because its default state is the closed or locked position. As a result, all an amateur rappeller has to do in order to stop his or her descent is to let go of the descender. Also, in the event a user is injured or becomes unconscious or incapacitated during descent, the descender will immediately stop his or her descent once the tension control device is released.

Other advantages of the invention include: quick loading, light weight, quick hook-up, and hands free locking for safety.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawings in which the reference number first appears.

FIG. 1 is a perspective view of the front of the descent control device with the cover in place;

FIG. 2 is a perspective view of the cover of the descent control device and a fastener for securing the cover to a frame of the descent control device;

FIG. 3 is a perspective view of the inside of the descent control device without the cover;

FIG. 4 is a planar view of the side of the descent control device;

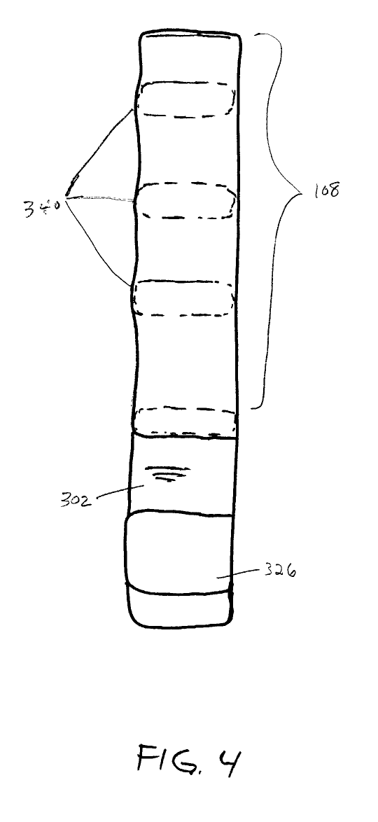

FIG. 5 is a perspective view of the inside of the descent control device having a rope positioned within the channel; and

FIG. 6 is a perspective view of the inside of the descent control device showing movement of a handle within an internal cavity of the frame;

FIG. 7 is a perspective view of the descent control device with the cover and having a rope positioned within the channel.

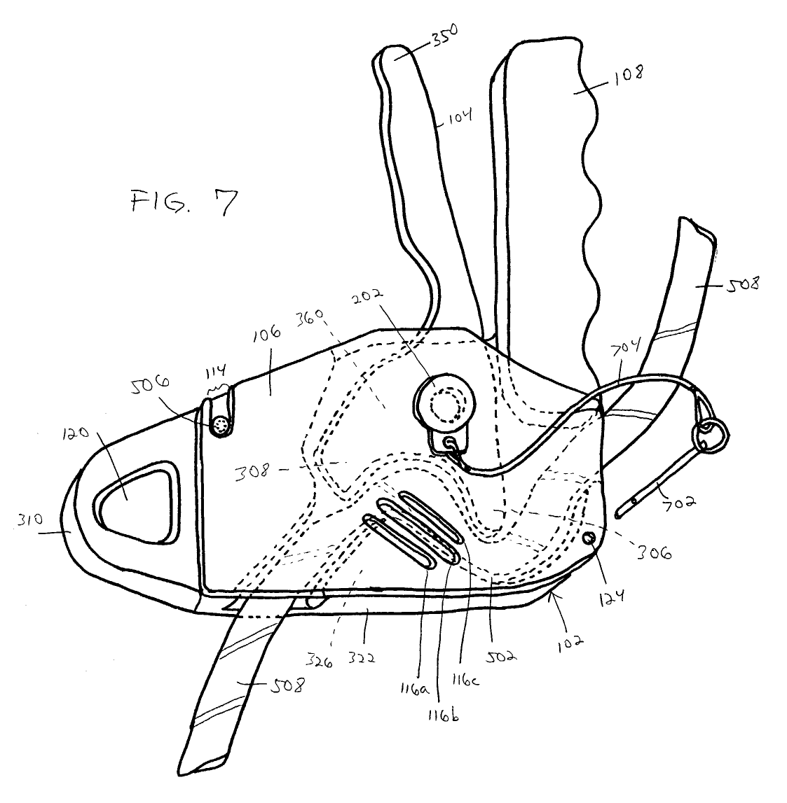

### EMBODIMENTS OF THE INVENTION

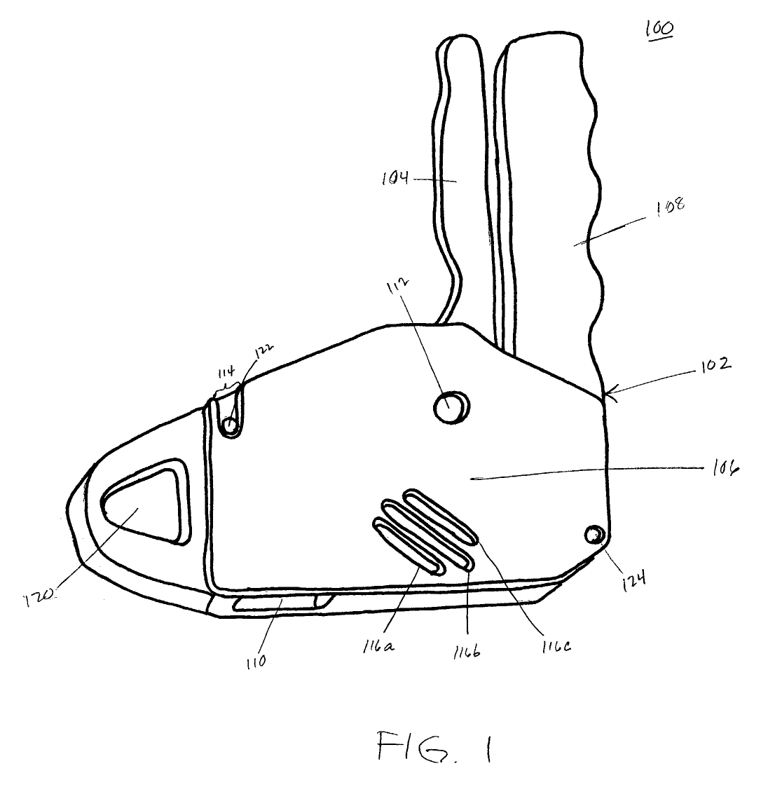

FIG. 1 shows an embodiment of the descent control device 100 of the present invention. The descent control device 100 preferably is made of a lightweight metal, such as certified lightweight aircraft aluminum, but alternatively may be made of other materials having the desired strength, weight, longevity, and safety characteristics. Non-limiting examples of alternative materials include: carbon composites, plastic polymers, stainless steel, and other metal alloys. The descent control device 100 preferably has a height of between 5 inches to about 7 inches, with a preferred height of between about 5.5 inches to about 6.5 inches, and a most preferred height of between about 5.75 inches to about 6.0 inches. The descent control device 100 preferably has a width of between 5 inches to about 7 inches, with a preferred width of between about 5.25 inches to about 6.5 inches, and a most preferred width of between about 5.5 inches to about 6 inches. The descent control device 100 preferably has a total depth, or thickness, of between ½ of an inch to about 2 inches, with a preferred width of about 1¼ inches.

The descent control device 100 includes a frame 102, a handle 104, and a cover 106. In a preferred embodiment, the cover 106 is rotatably connected to the frame 102 about a fastener 202 that is inserted through a central aperture 112 in the cover. The central aperture 112 extends all the way through the descent control device 100 from the top surface of the cover 106, through the handle 104, and through to the bottom surface of the frame 102. The fastener 202 preferably is permanently connected to the descent control device 100 by means known to those skilled in the art such as welding. As a result, the cover 106, while being rotatable, preferably is not removable from the descent control device 100. Alternatively, the fastener 202 may be detachably connected to the descent control device 100 such that the cover 106 is removable from the descent control device 100.

The cover 106 includes a corner aperture 124 for receiving a retaining pin 702 that prevents the cover 106 from rotating about the fastener 202. The corner aperture 124 extends downward from the top surface of the cover 106 through to the bottom surface of the frame 102. The cover 106 also includes a slot 114 positioned diagonally opposite the corner aperture 124. The slot 114 is adapted to receive the head 506 of a locking pin 504 which is inserted through, and permanently fixed within, aperture 122 thereby limiting the direction in which the cover 106 may rotate. The cover 106 includes a plurality of slits 116a-c for dissipating heat created from friction as a rope 508 passes through the descent control device 100. The cover 106 is shown with three slits 116a-c for convenience purpose only. It would be readily apparent to design and use a cover 106 having a different number of slits 116a-c.

As shown in FIG. 1, the shape of the cover 106 is precision fit to the outline (or perimeter shape) of the frame 102 and sits atop the frame 102 such that a grip 108, an opening 120, and the handle 104 extend from beneath the cover 106. When rope 508 is threaded through the descent control device 100 and exits through the first opening 110, the cover 106 is secured in a closed position. The cover 106 thus prevents the rope 508 from inadvertently being detached from the descent control device 100. Because the cover 106 is permanently attached to the frame 102 and handle 104, the cover 106 cannot be lost or misplaced. By rotating the cover 106 about the fastener 202 to an open position, a rope 508 can be quickly and easily threaded through the descent control device 100. By rotating the cover 106 about the fastener 202 to a closed position, the rope 508 is quickly and easily secured in place.

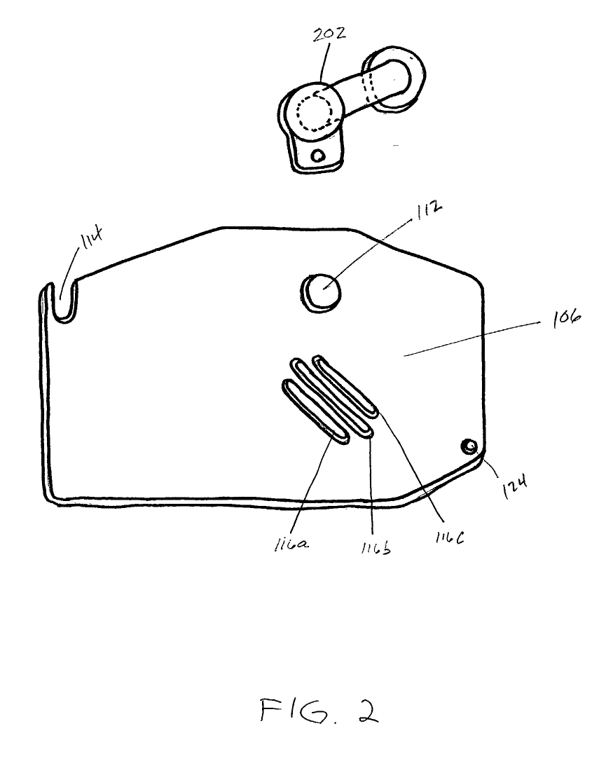

FIG. 2 shows the cover 106 without the frame 102 and handle 104. As discussed above, the fastener 202 intersects the descent control device 100 through the center aperture 112, and as will be discussed in more detail below, through the handle 104 and frame 102. The fastener 202 preferably is made of stainless steel, but alternatively may be made of other suitable materials known to one of ordinary skill in the art. The fastener 202 preferably is welded to the bottom of the frame 102 and is secured to the top surface of the cover 106 by a counter washer.

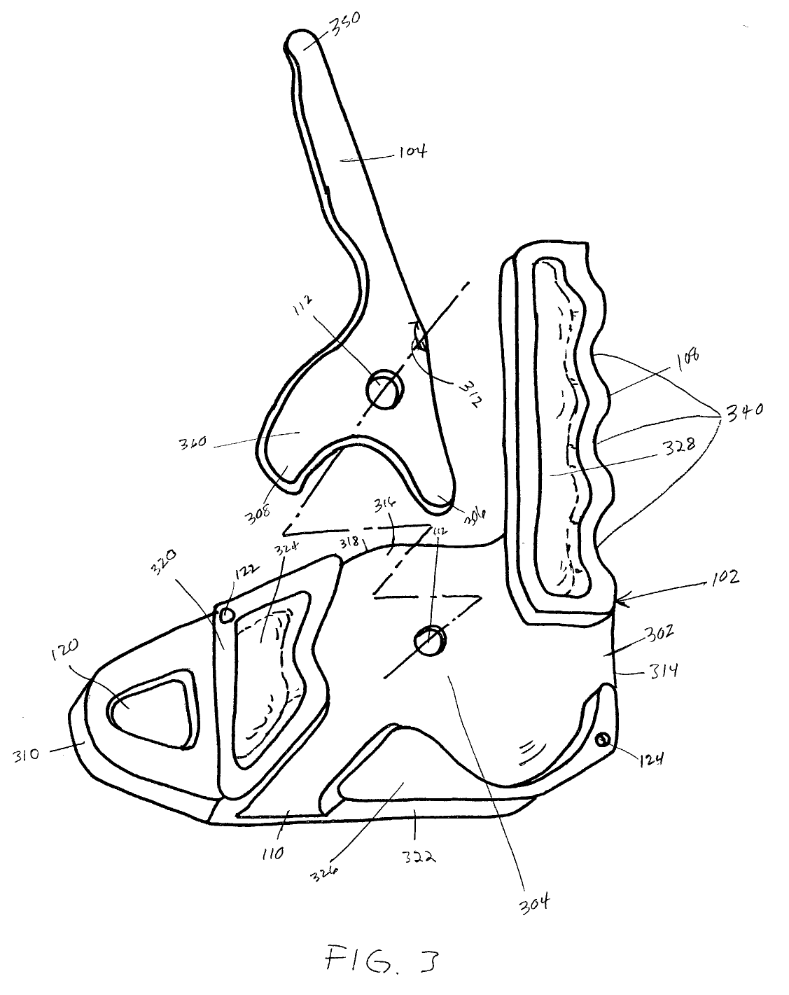

FIG. 3 shows the descent control device 100 with the cover 106 removed. More specifically, FIG. 3 shows the relationship of the handle 104 and the frame 102. The frame 102 preferably is formed as a single piece by means such as machining, but optionally may be made of component parts joined together by means such as welding. The frame 102 has a first end 310, second end 314, top 318, bottom 322, and preferably three openings. A first opening 110 is located through the bottom 322 of the frame 102. A second opening 302 is located through the second end 314 of the frame 102. The first and second openings 110, 302 are adapted for receiving a rope 508 that is threaded through the descent control device 100. A third opening 316 is located through the top 318 of the frame 102 for accommodating the handle 104. An internal cavity 304 interconnects the first, second, and third openings 110, 302, 316. The center aperture 112 discussed above extends through the internal cavity 304 of the frame 102. The internal cavity 304 is recessed in the frame 102, thereby creating a surface in the frame 102 below the surface on which the cover 106 rests and on which the handle 104 and threaded rope 508 rest.

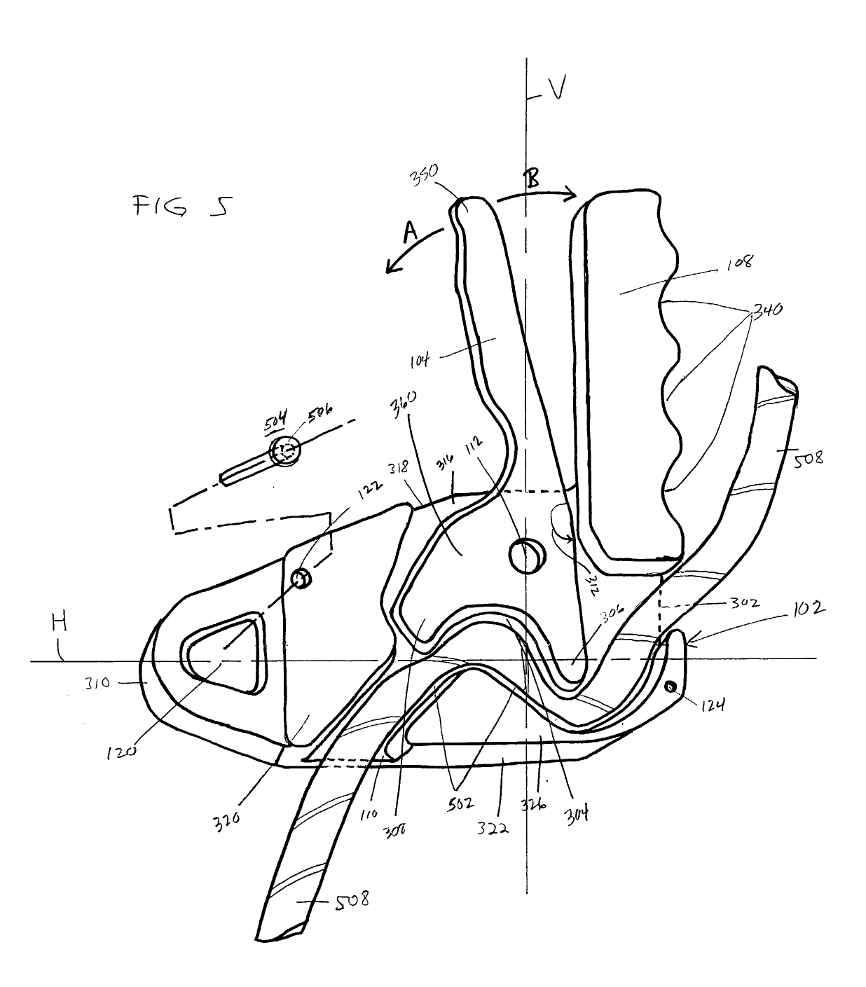

The bottom wall 326 and side wall 320 are formed as a result of the internal cavity 304 being recessed. The upper surface of the bottom and side walls 326, 320 is the surface on which the cover 106 is positioned when in place. As shown in FIG. 3, the side wall 320 may be hollowed out thereby creating a pocket of space 324 and reducing the weight of the descent control device 100. Alternatively, the side wall 320 may be substantially solid as shown in FIG. 5. The aperture 122 adapted for receiving a locking pin 504 extends through the side wall 320 of the frame 102. The bottom wall 326 extends along the bottom of the descent control device 100 from the first opening 110 to the second opening 302. The comer aperture 124 discussed above extends through the bottom wall 326.

Adjacent the side wall 320 is a means for attaching the descent control device 100 to a user. A preferred attaching means is an opening 120 in the frame 102 through which a carabineer or other means for connecting to a user's harness may be inserted. A grip 108 is positioned between the second and third openings 302, 316 in the frame 102. The grip 108 extends up and away from the frame 102 in a direction along a generally vertical axis V. Thus, the grip 108 is essentially perpendicular to the direction in which a rope 508 is threaded through the frame 102 from the second opening 302 to the first opening 110. As a result, the frame 102 is generally in the shape of a reverse-“L” with the grip 108 forming the first, vertical leg of the “L” and the remainder of the frame 102 forming the second, horizontal leg of the “L.” The grip 108 preferably includes finger grooves 340 for increased user comfort and also to prevent the user's hand from slipping off the grip 108. The grip 108, like the side wall 320, may be hollowed out thereby creating a pocket space 328 and further reducing the weight of the descent control device 100.

As shown in FIG. 3, the handle 104 of the descent control device 100 is generally “Y” shaped with a first end 350 extending away from the frame 102 in a direction generally parallel to the direction in which the grip 108 extends, and a second end 360 extending into the internal cavity 304 of the frame 102. The second end 360 of the handle 104 includes first and second means for engaging a rope 508 that is threaded through the descent control device 100. In the preferred embodiment, the first engaging means is a first projection 306, and the second engaging means is a second projection 308.

The center aperture 112 extends through the handle 104 near its second end 360 and allows the handle 104 to be rotatably connected to the frame 102 and cover 106 via the fastener 202 such that the handle 104 pivots around the shaft of the fastener 202. When the handle 104 is properly positioned in the internal cavity 304 of the frame 102, the center aperture 112 is aligned through the cover 106, the handle 104, and the frame 102. The handle 104 rests beneath the cover 106 in the internal cavity 304.

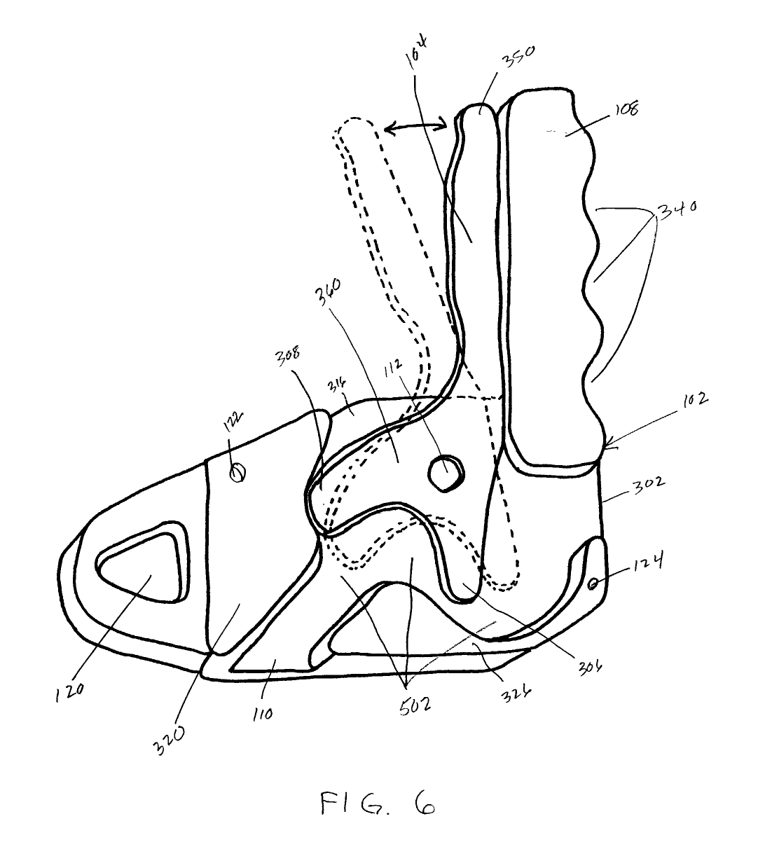

The first and second projections 306, 308 of the second end 360 of the handle 104 extend toward the bottom wall 326 of the frame 102 thereby forming a channel 502 through which a rope 508 may be threaded from the second opening 302 to the first opening 110. The channel 502 extends along a generally horizontal axis H from the first opening 110 to the second opening 302. As the first end 350 of the handle 104 extends toward the bottom wall 326, the side of the handle 104 with the first projection 306 bends slightly near the second end 360 of the handle 104 thereby creating an angle 312. That is, the second end 360 of the handle 104 is angled from the first end 350. The degree of the angle 312 may be altered to control the width of the channel 502 between the first projection 306 and the bottom wall 326. As shown in FIG. 6, the handle 104 rotates within the third opening 316 about the fastener 202 which is inserted through the center aperture 112. By rotating the handle 104, the width of the channel 502 may be controlled.

In operation, the descent control device 100 is used by connecting the opening 120 to a user's harness, often by means of a carabineer, and threading a segment of rope 508 through the frame 102. To thread the rope 508 through the frame 102, the retaining pin 702 running through the corner aperture 124 and the cover 106 is removed. In a preferred embodiment, the retaining pin 702 is connected permanently to the fastener 202 by means known to one of ordinary skill in the art, such as, for example, by a wire 704. As a result, the retaining pin 702 cannot be lost when removed because the retaining pin 702 is connected to the fastener 202 which is permanently connected to the descent control device 100. The retaining pin 702 locks the cover 106 in place thereby preventing the cover 106 from rotating about the fastener 202. The retaining pin 702 preferably is a compression pin having a detent ball on its bottom that must be compressed in order to remove the pin from the corner aperture 124.

Once the retaining pin 702 is removed, the cover 106 is rotated about the fastener 202 in a counterclockwise direction. The cover 106 can rotate only in the counterclockwise direction due to the presence of locking pin 504 which is positioned in the aperture 122 in the side wall 320 of the frame 102. The locking pin 504 preferably has a head 506 that extends slightly above the surface of the side wall 320. The slot 114 in the cover 106 slides under the head 506 of the locking pin 504 when the cover 106 is closed over the frame 102.

After rotating the cover 106 to an open position as discussed above, the first end 350 of the handle 104 is rotated in the direction of the grip 108 to clear the channel 502. As shown in FIG. 5, the first and second projections 306, 308 of the handle 104 define the lower boundary of the channel 502. In one embodiment, the first and second projections 306, 308 are shaped such that maximum rotation of the first end 350 of the handle 104 toward the grip 108 maximizes the width of the channel 502 between the bottom wall 326 and the first and second projections 326, 328.

In an alternative embodiment, the handle 104 has an angle 312 near the second end 360 on the first projection 306 of the handle 104 such that upon maximum rotation of the first end 350 of the handle 104 toward the grip 108, the first projection 306 constricts the channel 502 thereby preventing, or slowing greatly, movement of the rope 508 through the channel 502. As such, the descent control device 100 has two engagement points, or brakes, to prevent the rope 508 from moving through the channel 502.

This embodiment is particularly desirable in emergency use applications when the user is inexperienced and likely frightened. Because of the circumstances, an inexperienced and frightened user may have a tendency to squeeze the handle 104 and grip 108 tightly thereby moving the first end 350 of the handle 104 all the way toward the grip 108. If the handle 104 does not have the angle 312, then the result of the user's tight squeeze of the handle 104 and grip 108 is that the channel 502 is opened to its maximum width and the user's rate of descent will likewise be at its maximum. In contrast, the angle 312 near the second end 360 of the handle 104 brings the first projection 306 sufficiently close to the bottom wall 326 of the frame 102 when a frightened user applies maximum pressure to the handle 104 and grip 108 that the first projection 306 pinches the rope 508 against the bottom wall 326. Depending on the weight of the user, his or her descent will either be stopped or the rate of descent will be greatly reduced by the first projection 306 pressing the rope 508 into the bottom wall 326 and pinching the rope 508. The first projection 306 thus acts as a secondary brake in addition to the second projection 308 which prevents descent when the descent control device 100 is in its default position.

The rope 508 is threaded through the channel 502 extending from the second opening 302 to the first opening 110. The channel 502 extends in a direction generally horizontal along axis H and generally perpendicular to the direction in which the both the handle 104 and grip 108 extend away from the frame 102. The handle 104 and grip 108 thus both are positioned above the first and second projections 306, 308 which serve as the means for engaging the rope 508 and controlling the rate of descent of the user. This positioning of the handle 104 and grip 108 in relation to the means for engaging the rope 508 makes the descent control device 100 of the present invention very easy use to use, so much so that it may be operated with a single hand. Once the rope 508 is threaded through the descent control device 100, the cover 106 is closed by rotating the cover 106 clockwise about the fastener 202 and sliding the slot 114 under the head 506 of the locking pin 504. A retaining pin 702 is then inserted through the corner aperture 124 to secure the cover 106 to the frame 102.

In the absence of applied pressure by the user to the handle 104 and/or grip 108, the handle 104 will be in a closed position, i.e., the channel 502 is constricted by the second projection 308. As a result, the rope 508 is prevented from moving through the channel 502. The positioning of the handle 104 and first and second projections 306,308 in this default position is due to upward pressure exerted by the rope 508 on the first projection 306 toward the first opening 302. The pressure is the result of the weight of the user hanging off of the descent control device 100. This pressure rotates the second end 360 of the handle 360 toward the first opening 302, in direction A on FIG. 5, which causes the second projection 308 to press the rope 508 against the bottom wall 326. As the second end 360 of the handle 104 is forced toward the first opening 302 and the first end 350 of the handle 104 is rotated away from the grip 108, the second projection 308, like the first projection 306, is forced toward the first opening 302. As the second projection 308 rotates in a direction toward the first opening 302, the second projection 308 comes into close proximity with the bottom wall 326 thereby “pinching” the rope 508 between the second projection 308 and the bottom wall 326. The second projection 308 exerts pressure against the rope 508 and into the bottom wall 326, thereby preventing the rope 508 from moving through the channel 502. In so doing, the second projection 308 acts as a primary brake to keep a user from descending down a rope 508 when the descent control device 100 is in its default position, such as when a user is simply hanging from the descent control device 100.

In order to activate the descent control device 100, a user must apply pressure to the first end 350 of the handle 104 towards the grip 108, thereby moving the handle 104 in direction B on FIG. 5. In so doing, the second end 360 of the handle 104 is rotated away from the first opening 302 and the second projection 308 is moved away from the bottom wall 326 thereby increasing the width of the channel 502. In this position, the rope 508 is allowed to pass through the channel 502 and the user descends down the rope 508. The user controls the rate of his or her descent by manipulating the handle 104, thereby changing the width of the channel 502 and applying pressure to the rope 508 through the first and second projections 306, 308.

The descent control device 100 of this invention is an exceptionally safe device because its default state is the closed or “locked” position, i.e., the user must press the handle 104 toward the grip 108, in direction B on FIG. 5, in order to open the channel 502 and allow rope 508 to slide through. When the user wants to continue his or her descent, he or she squeezes the handle 104 toward the grip 108 of the frame 102. The more the user squeezes the handle 104 toward the grip 108, the faster his/her rate of descent. The result is that the handle rotates clockwise and the second projection 308 moves away from the bottom wall 326 thereby clearing the channel 502 and allowing the rope 508 to slide through. The user can stop his or her descent simply by letting go of the descent control device 100, in which case the handle 104 will again prevent the rope 508 from sliding through the channel 502. Also, if the user squeezes the handle 104 and grip 108 too tightly thereby moving the first end 350 of the handle 104 all the way toward the grip 108, then the result of the user's tight squeeze is that the first projection 306 is brought sufficiently close to the bottom wall 326 of the frame 102 that the first projection 306 pinches the rope 508 against the bottom wall 326. The first projection 306 thus acts as a secondary brake in addition to the second projection 308.

In an alternative embodiment, the descent control device 100 also may include foam or other cushioning material on the grip 108 or the handle 104. Additionally, the grip 108 and/or the handle 104 may be textured to prevent the user's hand from slipping. The descent control device 100 also may include a spring-loaded center punch in the grip 108 for breaking glass. This would be especially useful for military or law enforcement applications where a user is required to rappel down the face of a building and enter the building through a window.

Alternative methods may be used to control the rate at which the rope 508 is fed through the descent control device 100 thereby controlling the rate of descent. For example, when used by professionals, such as military or police personnel, the channel 502 may be less convoluted or wider, or the first and second projections 306, 308 may be less severe (shorter in length and/or smaller in shape), resulting in a more rapid descent because the channel 502 is less restricted during use. Conversely, when used by amateurs or those unaccustomed to rappelling, the channel 502 may be more convoluted, or the first and second projections 306, 308 may be more severe (longer in length and/or larger in shape), or even additional projections may be added, to greatly restrict the flow of the rope 508 through the channel 502, resulting in slower descent.

### Conclusion

While various embodiments of the present invention have been described, it should be understood that they have been presented by the way of example only, and not limitation. It will be understood by those skilled in the art that various changes in form and details may be made therein without departing from the spirit and scope of the invention. Thus, the breadth and scope of the present invention should not be limited by any of the above-described exemplary embodiments, but should be defined in accordance with the described terms and their equivalents.

What is claimed is:

1. A descent control device for use with a rope, comprising:
a frame comprising:
a first end, a second end, a first opening, a second opening, a third opening, and an internal cavity connecting said first opening, said second opening and said third opening, wherein said first opening and said second opening form a channel having a width and extending along a generally horizontal axis in a direction from said first opening to said second opening, said channel being adapted for receiving a rope;
a grip positioned between said second opening and said third opening in proximity to said second end of said frame, said grip extending away from said frame along a generally vertical axis; and
a means for attaching the descent control device to a user, wherein said means for attaching is in proximity to said first end of said frame generally across from said second opening near the horizontal axis through which said channel extends;
a handle rotatably mounted to said frame within said internal cavity and having a first end that extends from said frame in a direction generally parallel to the direction in which said grip extends, and a second end that forms an upper boundary to the channel formed by said first opening and said second opening such that said second end of said handle is adapted for modifying the width of said channel upon rotation of said first end of said handle; and
a cover pivotally mounted to said frame for maintaining the rope in said channel.

2. The descent control device of claim 1, wherein said second end of said handle includes a first means and a second means for engaging the rope threaded through said channel.

3. The descent control device of claim 2, wherein said first means for engaging the rope is a first projection extending from said second end of said handle and said second means for engaging is a second projection extending from said second end of said handle.

4. The descent control device of claim 1, wherein said first end of said handle extends from said second end of said handle at an angle.

5. The descent control device of claim 1, wherein said means for attaching the descent control device to a user is an opening in said frame for receiving a carabineer.

6. The descent control device of claim 1, wherein said cover, said handle, and said frame are connected by a fastener inserted through a center aperture that extends from said cover through said handle and said frame.

7. The descent control device of claim 6, wherein said cover rotates about said fastener.

8. The descent control device of claim 6, wherein said handle rotates about said fastener.

9. The descent control device of claim 1, wherein said cover is locked in place by a retaining pin inserted through a corner aperture that extends from said cover through said frame.

10. The descent control device of claim 5, wherein said frame further comprises a locking pin inserted through an aperture in proximity to said opening to limit rotation of said cover.

11. The descent control device of claim 10, wherein said cover further comprises a slot adapted for receiving said locking pin.

12. The descent control device of claim 1, wherein said cover further comprises two or more slits for dissipating heat generated by friction as the rope passes through said channel.

13. The descent control device of claim 1, wherein said grip further comprises finger grooves.

14. The descent control device of claim 1, wherein said frame further comprises recessed portions.

15. The descent control device of claim 14, wherein said recessed portions are located in said grip.

16. A method for descending down a rope, comprising the steps of:
(a) securing the rope to an anchor point;
(b) threading the rope through a descent control device comprising:
a frame comprising:
a first end, a second end, a first opening, a second opening, a third opening, and an internal cavity connecting said first opening, said second opening and said third opening, wherein said first opening and said second opening form a channel having a width and extending along a generally horizontal axis in a direction from said first opening to said second opening, said channel being adapted for receiving a rope;
a grip positioned between said second opening and said third opening in proximity to said second end of said frame, said grip extending away from said frame along a generally vertical axis; and
a means for attaching the descent control device to a user, wherein said means for attaching is in proximity to said first end of said frame generally across from said second opening near the horizontal axis through which said channel extends;
a handle rotatably mounted to said frame within said internal cavity and having a first end that extends from said frame in a direction generally parallel to the direction in which said grip extends, and a second end that forms an upper boundary to the channel formed by said first opening and said second opening such that said second end of said handle is adapted for modifying the width of said channel upon rotation of said first end of said handle; and
a cover pivotally mounted to said frame for maintaining the rope in said channel;
(c) attaching the descent control device to a user; and
(d) controlling how fast the user descends down the rope by rotating the handle of the descent control device.

17. The method of claim 16, wherein said second end of said handle includes a first means and a second means for engaging the rope threaded through said channel.

18. The method of claim 17, wherein said first means for engaging the rope is a first projection extending from said second end of said handle and said second means for engaging is a second projection extending from said second end of said handle.

19. The method of claim 18, wherein said first end of said handle extends from said second end of said handle at an angle.
